(19) United States
(12) Patent Application Publication
(10) Pub. No.: US 2005/0281955 A1
(43) Pub. Date: Dec. 22, 2005

(54) Apparatus for producing silver salt photothermographic material and production method of coater for producing silver salt photothermographic material

(76) Inventor: Keiichi Aoki, Tokyo (JP)

Correspondence Address: CANTOR COLBURN, LLP, 55 GRIFFIN ROAD SOUTH, BLOOMFIELD, CT, 06002, US

(21) Appl. No.: 11/210,972

(22) Filed: Aug. 24, 2005

Related U.S. Application Data
(62) Division of application No. 10/689,454, filed on Oct. 20, 2003.

(30) Foreign Application Priority Data
Oct. 25, 2002 (JP) JP2002-310946

(51) Int. Cl. B05D 1/36

(52) U.S. Cl. 427/402

(57) ABSTRACT

In an apparatus in which when a photothermographic material is produced, a photosensitive layer liquid coating composition including a silver component and a non-photosensitive protective layer liquid coating composition are applied onto a web employing a slot coater, a coating apparatus for producing a photothermographic material wherein the slot coater is constituted so that the center-line surface roughness Ra of the lip plane, which comes into contact with at least the photosensitive layer liquid coating composition, is equal to or less than 0.5 μm.

### CROSS REFERENCE TO RELATED APPLICATIONS

The present application is a divisional application of U.S. patent application Ser. No. 10/689,454, filed on Oct. 20, 2003, the entire contents of which are incorporated herein by reference. The Ser. No. 10/689,454 application claimed the benefit of the date of the earlier filed Japanese Patent Application No. JP 2002-310946 filed Oct. 25, 2002, and priority is also claimed in the present divisional application.

### BACKGROUND OF THE INVENTION

The present invention relates to a coating apparatus for producing silver salt photothermographic materials (hereinafter referred to simply as photothermographic material) and a production method of a coater, and in more detail to a coating apparatus for producing a photothermographic material, which is provided with either a slot coater or a slide coater which does not result in deposition of silver components by the continuous use for an extended period of time, and a production method of the coater used in the aforesaid apparatus.

A photothermographic material which is related to the present invention may be comprised of conventionally known and employed constitutions.

Known as a production method is one employing a technique in which simultaneous multilayer coating is carried out employing a slot coater (for example, refer to Japanese Patent Publication Open to Public Inspection No. 2000-15173), and the other employing a technique in which simultaneous multilayer coating is carried out employing a slide coater (for example, refer to U.S. Pat. No. 5,849,363).

With regard to the surface property of a slot coater as well as a slide coater, heretofore, various techniques have been proposed. For example, Japanese Patent Publication Open to Public Inspection No. 2-207865 describes specifications of the surface roughness of the lip plane on the downstream side of the slot coater, while Japanese Patent Publication Open to Public Inspection No. 6-339659 describes specifications of the surface roughness of the lip plane at the corners on the downstream side of the slot coater. Further, Japanese Patent Publication Open to Public Inspection No. 6-15211 describes specifications of the surface roughness of the slide plane of the slide coater, while Japanese Patent Publication Open to Public Inspection No. 7-108207 describes specifications of the surface roughness of the slit plane of the slide coater.

The photothermographic material comprises at least one photosensitive layer comprising silver components and at least one protective layer. Each of these layers is formed by applying a liquid coating composition for each layer onto the surface of a web which and subsequently drying them. When a liquid coating composition is coated, from the viewpoint of enhancing manufacturing efficiency, it is preferable to carry out simultaneous multilayer coating, employing a slot coater or a slide coater. However, in a coating system in which the aforesaid conventional techniques are employed, when coating is continuously carried out for an extended period of time, streaking problems occasionally occur on the coating surface.

### SUMMARY OF THE INVENTION

As can clearly be seen from the foregoing, an embodiment of the present invention may provide a coating apparatus for producing photothermographic materials, provided with a coater which does not result in streaking problems on the coating surface, even though employed over an extended period of time, as well as a production method of the coater employed in the aforesaid apparatus.

The aforesaid may be achieved employing any one of structures 1-4 described below.

In an apparatus in which when a photothermographic material is produced, a photosensitive layer liquid coating composition comprising a silver component and a non-photosensitive protective layer liquid coating composition are applied onto a web employing a slot coater, a coating apparatus for producing a photothermographic material wherein the aforesaid slot coater is constituted so that the center line surface roughness Ra of the lip plane, which comes into contact with at least the photosensitive layer liquid coating composition comprising the silver component, is equal to or less than 0.5 μm.

In an apparatus in which when a photothermographic material is produced, a photosensitive layer liquid coating composition comprising a silver component and a non-photosensitive protective layer liquid coating composition are applied onto a web employing a slide coater, a coating apparatus for producing a photothermographic material wherein the aforesaid slide coater is constituted so that the center line surface roughness Ra of the slide plane, which comes into contact with at least the photosensitive layer liquid coating composition comprising the silver component, is equal to or less than 0.5 μm.

In a production method of a slot coater to apply a photosensitive layer liquid coating composition comprising a sliver component and a non-photosensitive protective layer liquid coating composition onto a web, for production of a photothermographic material, a production method of a slot coater for producing a photothermographic material wherein the lip plane of the aforesaid slot coater, which comes into contact with at least the aforesaid photosensitive layer coating composition comprising the silver component, is subjected to final grinding employing a grindstone of a grain size which is less than that of the slit plane of the aforesaid slot coater.

In a production method of a slide coater to apply a photosensitive layer liquid coating composition comprising a sliver component and a non-photosensitive protective layer liquid coating composition onto a web, for production of a photothermographic material, a production method of a slide coater for producing a photothermographic material wherein the slide plane of the aforesaid slide coater, which comes into contact with at least the aforesaid photosensitive layer coating composition comprising the silver component, is subjected to final grinding employing a grindstone of a grain size which is less than that of the slit plane of the aforesaid slide coater.

The center line surface roughness, as described in the present invention, may be determined based on the methods described in Japanese Industrial Standards JIS B 0601: 2001 (corresponding to ISO 468-1982, 3274-1975, 4287/1-1984, 4287/2-1984, and 4288-1985). Further, the grain size of the grindstone used in the final grinding, as described in the present invention, may represent the grain size prescribed in JIS R6001:1988.

Investigations performed by the inventors of the present invention resulted in the following discoveries. When a coater was continuously used for an extended period of time, phenomena occurred in which silver components were deposited and securely adhered onto the lip plane of a slot coater or the slide plane of a slide coater which came into contact with the photosensitive layer comprising silver components. As a result, streaking problems were caused by the aforesaid securely adhered substances. Further, many of them adhered along with the grinding marks of grinding which was a finishing process for the coater die.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic view of the slot coater according to the present invention.

FIG. 2 is an enlarged view of the major section of the slot coater according to the present invention.

FIG. 3 is a view showing the lip section of the slot coater according to the present invention.

FIG. 4 is a schematic view of the slide coater according to the present invention.

FIG. 5 is an enlarged view of the major section of the slide coater according to the present invention.

FIG. 6 is a view showing the slide plane of the slide coater according to the present invention.

### DETAILED DESCRIPTION OF THE PREFERRED EMBODIMENT

The embodiments of the present invention will now be described while clarifying the formation mechanism of the aforesaid adhered substances due to deposition of silver components.

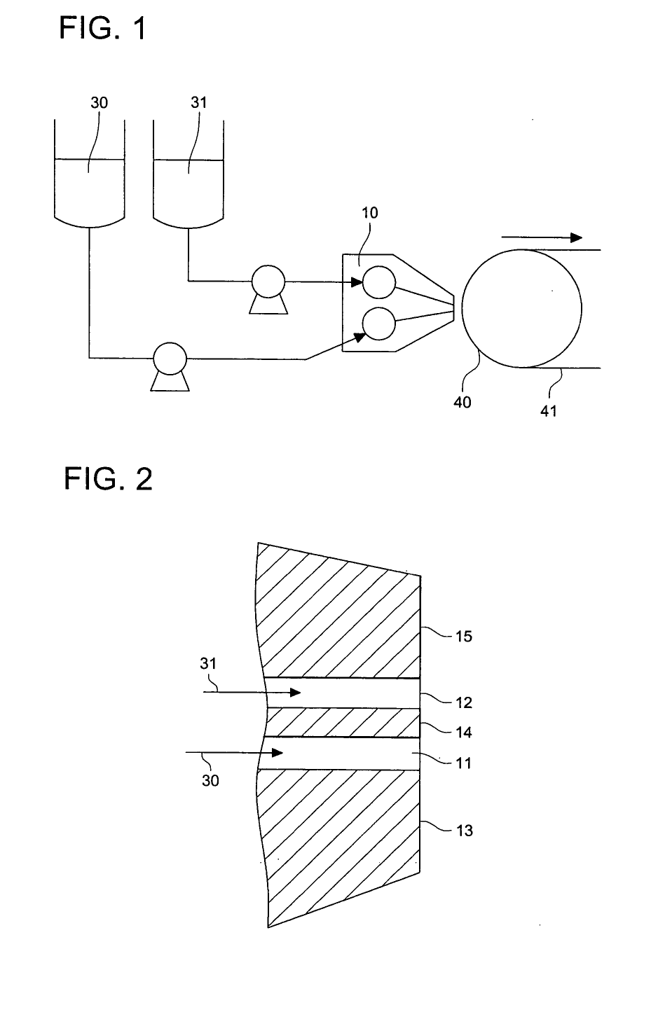

Initially, an embodiment which utilizes slot coater 10 for coating two layers will be described with reference to FIG. 1. Aforesaid slot coater 10 for coating two layers is constituted in such a manner that photosensitive layer liquid coating composition 30 is discharged from lower layer slit 11 and protective layer liquid coating composition 31 is discharged from upper slit 12. Coating is performed in such a manner that web 41 which is conveyed while supported by back-up roller 40 is allowed to approach the front plane of lips 13-15 of slot coater 10, and a photosensitive layer and a protective layer are simultaneously formed.

As shown in FIG. 2 as an enlarged view of the coating section, photosensitive layer liquid coating composition 30 discharged from lower layer slit 11 is applied onto web 41 while brought into contact with front lip 13 and center lip 14 which are arranged in the stated order viewed upstream of the web. On the other hand, protective layer liquid coating composition 31 discharged from upper layer slit 12 is also applied onto web 41 while brought into contact with back lip 15 which is arranged downstream.

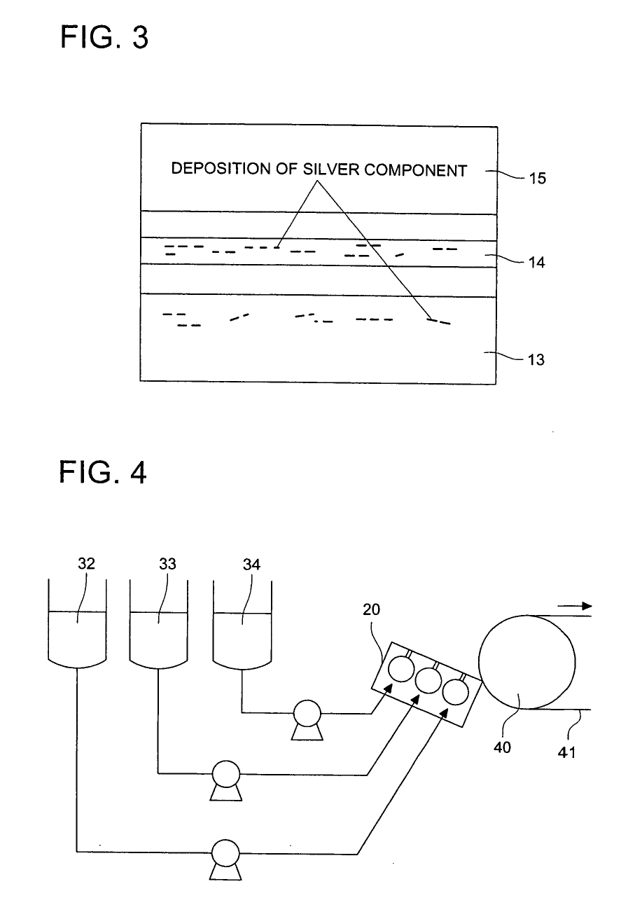

When coating is achieved employing a conventional slot coater, no coating problems occur during the use of a fresh coater (a die). However, when the same coater (the die) is continuously used for an extended period of time, streaking problems occasionally occur at a definite position crossweb direction. Causes for the problems were investigated, and it was discovered that as shown in FIG. 3, when each of lips 13-15 was observed in the crossweb direction, silver components were deposited and adhered onto the portion of front lip 13 and center lip 14. It was also discovered that the aforesaid silver components were adhered along to grinding marks formed during finish grinding process of lips 13-15.

Accordingly, various investigations were conducted to overcome the aforesaid problems. It was then discovered that in order to minimize the deposition and secured adhesion of silver components, it was effective to finish the surface of front lip 13 and center lip 14, which came into contact with the photosensitive layer liquid coating composition, to result in near mirror plane smoothness. The aforesaid investigations were conducted further. As a result, it was proved that when the center line surface roughness of aforesaid lips 13 and 14 was 0.5 μm or less, no problems occurred due to adhesion of silver salts. Incidentally, the lower limit of the aforesaid roughness is approximately 0.05 μm even though it is not specified.

By reducing the grain size of a grindstone in the grinding process of the coater die, it is possible to finish the surface smoothly. However, when the grain size is reduced, finishing accuracy of the coater die, such as straightness, tends to degrade. Therefore, in order to maintain the accuracy of the entire coater die, it is preferable that desired portions are finished employing a grindstone of a smaller grain size. In the case of aforesaid slot coater 10, in terms of accuracy, it is advantageous that lips 13-15, or at least front lip 13 and center lip 14 are subjected to final grinding employing a grindstone of a smaller grain size. Accordingly, the portion of slits 11 and 12 which commonly come into contact with a liquid coating composition, and the portion of lips 13-15 are commonly finished to be smoother than the exterior surface of the coater die upon considering washability. With regard to accuracy of the coater die, it is preferable that the plane of front lip 13 and center lip 14 is subjected to final grinding employing a grindstone of a smaller grain size than that of the grindstone employed for the plane of slit 11 which results in a greater effect on the accuracy in the crossweb direction.

Specifically, in the initial stage of the grinding process of a coater die, it is preferable that the whole die is ground employing a grindstone of a larger grain size of #200 or less. Thereafter, it is preferable that the plane of slits 11 and 12 which come into contact with liquid coating compositions as well as the plane of lips 13-15 are ground employing a grindstone of approximately #200-500, and the surface of lips 13-15 or at least front lip 13 and center lip 14 is subjected to final grinding employing a grindstone of a smaller grain size of approximately #500-700. Incidentally, the length of each lip is customarily in the range of 0.1-5 mm, and is preferably in the range of 0.5-3 mm.

Descriptions will now be made utilizing 3-layer coating slide coater 20, shown in FIG. 4, as an example. The aforesaid slide coater 20 achieves coating as follows. Carrier layer liquid coating composition 32 is discharged from lowest layer slit 21, and photosensitive layer liquid coating composition 33 is discharged from central layer slit 22, while protective layer coating composition 34 is discharged from uppermost layer silt 23. Discharged liquid coating compositions flow down while laminated on slide planes 24-26. The lip plane of slide coater 20 is allowed to approach web 41 which is conveyed while supported by back-up roller 40 so that a carrier layer, a photosensitive layer, and a protective layer are simultaneously applied onto the aforesaid web.

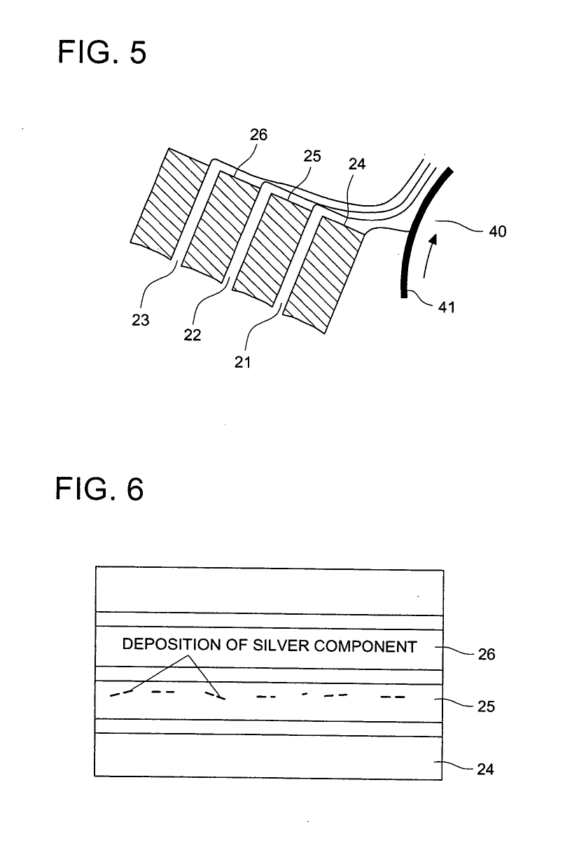

FIG. 5 shows an enlarged view of the coating section of aforesaid slide coater 20. Carrier layer liquid coating composition 32, discharged from lowest layer slit 21, flows down while brought into contact with first slide surface 24. Photosensitive layer liquid coating composition 33, discharged from central layer slit 22, flows down while brought into contact with second slide plane 25 and is laminated onto the layer of carrier layer liquid coating composition 32. Protective layer liquid coating composition, discharged from uppermost layer slit 23, flows down while brought into contact with third slide plane 26 and is laminated onto the layer of photosensitive layer liquid coating composition 33. These liquid coating compositions supplied in a laminated state are thus applied onto web 41 in a three-layer configuration.

In a conventional slide coater, when a fresh coater die is employed, it is possible to achieve coating without any problems in the same manner as the conventional slot coater described above. However, when the same coater die is used for an extended period of time, streaking problems occasionally occur at definite positions in the crossweb direction. The cause of this was then investigated, and it was clarified that silver components were securely deposited onto second slide plane 25 which came into contact with photosensitive layer liquid coating composition 25. FIG. 6 is a view in which the slide plane is viewed from the upper surface. In addition, it was discovered that the aforesaid silver components were adhered along grinding marks due to grinding during the finishing process of the slide plane.

In order to overcome the aforesaid problems, in the same manner as the aforesaid slot coater 10, it is effective to finish the surface of slide plane 25, which comes into contact with photosensitive layer liquid coating composition 33, almost to a mirror plane. When the center line surface roughness of the aforesaid slide plane was 0.5 μm or less, it was discovered that no problems occurred due to the aforesaid deposition. In this slide coater 20, it is preferable that in order to maintain the desired accuracy of the entire coater die, only necessary portions are subjected to final grinding employing a grindstone of a smaller grain size. In the case of this slide coater 20, in terms of accuracy, it is advantageous that only the slide plane is subjected to final grinding employing a grindstone of a smaller grain size. Accordingly, it is preferable that at least second slide plane 25, which comes into contact with photosensitive layer liquid coating composition 33 is subjected to final grinding employing a grindstone of a smaller grain size, rather than the slit plane which greatly affects accuracy of the layer thickness in the crossweb direction of accuracy of the coater die.

In practice, in the initial stage of the grinding process of a coater die, it is preferable that the entire die is subjected to grinding employing a grindstone of a relatively large grain size of #200 or less, and thereafter, the slit plane and the slide plane, which come into contact with liquid coating compositions, are subjected to grinding employing a grindstone of a grain size of about #200-about #500, and slide planes 24-26, or at least only slide plane 25 is subjected to final grinding employing a grindstone of a smaller grain size of about #500-about #700.

Incidentally, the carrier layer may incorporate silver components. In such a case, it is preferable that first slide plane 24 is finished to result in the same smoothness as second slide plane 25. As noted above, it is preferable that when the silver components are incorporated into a plurality of layers, all the slide planes which come into contact with the aforesaid layer are to be finished to a smooth surface. Incidentally, the length of each slide plane is customarily 1-100 mm in the sliding direction, and is more preferably 30-80 mm.

Photothermographic materials are detailed, for example, in U.S. Pat. Nos. 3,152,904 and 3,457,075, D. Morgan, Dry Silver Photographic Material, and D. Morgan and B. Shely, Thermally Processed Silver Systems, Imaging Processes and Materials, Neblette, 8th edition, edited by J. Sturge, V. Walworth, and A. Shepp, page 2, 1969. Of these, in the present invention, it may be preferable that photosensitive materials are thermally developed at 80-140° C. and are not fixed. In such a case, silver halide and organic silver salts which remain on the unexposed portions are not removed and remain in the aforesaid photosensitive material. The present invention may be preferably applied to such photothermographic materials. Employed as liquid composition formulas which are applied to a web as well as production methods of liquid compositions may be any of those commonly known in the art.

### EXAMPLES

Applied onto a 175 μm thick, 1,000 mm wide, polyethylene terephthalate web were a photosensitive layer as a lower layer at a wet coating weight of 75 g/m², and a protective layer as an upper layer at a wet coating weight of 25 g/m² under the conditions of a coating rate of 30 m/minute and a coating width of 960 mm, while employing a multilayer slot coater which had been subjected to grinding as described below. During continuous coating for 3,000 hours, the number of streaking problems which resulted on the coating surface were determined. After finishing coating for 3,000 hours, the lip plane was inspected and the number of depositions due to adhered foreign substance was determined.

The carrier layer liquid coating composition, the photosensitive layer liquid coating composition, and the protective layer liquid coating composition were prepared employing conventional compositions and methods known in the art.

### Comparative Example 1

The entire plane of each block of the slot coater was once subjected to grinding employing a grindstone of a grain size of #140. Thereafter, the slit plane and the lip plane of each block were subjected to grinding employing a grindstone of a grain size of #320, whereby a slot coater was prepared. By employing the aforesaid slot coater, a photothermographic material was produced. Table 1 shows the results.

### Example 1

Grinding was achieved in the same manner as Comparative Example 1. Thereafter, only the lip plane of all blocks was subjected to grinding employing a grindstone of a grain size of #650, and a slot coater was then prepared. By employing the resulting slot coater, a photothermographic material was produced. Table 1 shows the results.

TABLE 1

| | |
|---|---|
| Center Line | After 3,000 Hours of Use |

| | | |
|---|---|---|
| Surface | | Number of |
| Roughness Ra | Number of | Foreign |
| (μm) | Streaking | substance |

| | Slit | Lip | Problem | Depositions on |
|---|---|---|---|---|
| | Plane | Plane | Lines | Lip Plane |
| Comparative | 1.05 | 0.95 | 12 | 21 |
| Example 1 | | | | |
| Example 1 | 1.08 | 0.38 | 0 | 0 |

### Comparative Example 2

The entire plane of each block of the slide coater was once subjected to grinding employing a grindstone of a grain size of #180. Thereafter, the slit plane and the slide plane of each block were subjected to grinding employing a grindstone of a grain size of #360, whereby a slide coater was prepared. By employing the aforesaid slide coater, experiments were conducted. Table 2 shows the results.

### Example 2

Grinding was achieved in the same manner as Comparative Example 1. Thereafter, only the slide plane of all blocks was subjected to grinding employing a grindstone of a grain size of #600, and a slide coater was then prepared. By employing the resulting slide coater, a photothermographic material was produced. Table 2 shows the results.

TABLE 2

| | |
|---|---|
| Center Line | After 3,000 Hours of Use |

| | | |
|---|---|---|
| Surface | | Number of |
| Roughness Ra | Number of | Foreign |
| (μm) | Streaking | substance |

| | Slit | Slide | Problem | Depositions on |
|---|---|---|---|---|
| | Plane | Plane | Lines | Lip Plane |
| Comparative | 0.99 | 0.90 | 6 | 15 |
| Example 2 | | | | |
| Example 2 | 1.04 | 0.44 | 0 | 0 |

Even though during production of photothermographic materials, one coater die is employed for an extended period of time, it is possible to minimize formation of streaking problems, whereby the problems initially described are overcome.

While the preferred embodiments of the present invention have been described using specific terms, such description is for illustrative purposes only, and it is to be understood that changes and variations may be made without departing from the spirit or scope of the appended claims.

1. A method of producing a slot coater for producing a silver salt photothermographic material by coating a photosensitive layer liquid coating composition comprising a silver component and a non-photosensitive protective layer liquid coating composition onto a web to be coated, the method comprising:
(a) preparing a grindstone of a grain size which is less than that for grinding a slit plane of the slot coater; and
(b) finishing grinding a lip plane of the slot coater with the grindstone prepared, the lip plane coming into contact with at least the photosensitive layer coating composition.

2. A method of producing a slide coater for producing a silver salt photothermographic material by coating a photosensitive layer liquid coating composition comprising a silver component and a non-photosensitive protective layer liquid coating composition onto a web to be coated, the method comprising:
(a) preparing a grindstone of a grain size which is less than that for grinding a slit plane of the slide coater; and
(b) finishing grinding a slide plane of the slide coater with the grindstone prepared, the slide plane coming into contact with at least the photosensitive layer coating composition.

3. The method of claim 1, wherein the finishing grinding of the lip surface is conducted employing a grindstone of a grain size #500-700.

4. The method of claim 1, wherein a length of each lip is in the range of 0.1-5 mm.

5. The method of claim 3, wherein a length of each lip is in the range of 0.1-5 mm.

6. The method of claim 4, wherein the length of each lip is in the range of 0.5-3 mm.

7. The method of claim 2, wherein the finishing grinding of the slide surface is conducted employing a grindstone of a grain size #500-700.

8. The method of claim 2, wherein a length of each slide plane of 1-100 mm in a sliding direction of the photosensitive layer liquid coating composition.

9. The method of claim 6, wherein a length of each slide plane is 1-100 mm in a sliding direction of the photosensitive layer liquid coating composition.

10. The method of claim 7, wherein the length of each slide plane is 30-80 mm in the sliding direction.
